(19) United States
(12) Patent Application Publication
(10) Pub. No.: US 2025/0074209 A1
(43) Pub. Date: Mar. 6, 2025

(54) VEHICLE TORQUE CONTROL METHOD AND APPARATUS, ELECTRONIC DEVICE, AND STORAGE MEDIUM

(71) Applicant: BYD COMPANY LIMITED, SHENZHEN (CN)

(72) Inventors: Heping LING, Shenzhen (CN); Mingchuan SHI, Shenzhen (CN); Hao ZHANG, Shenzhen (CN); Chao YIN, Shenzhen (CN); Hongxia WANG, Shenzhen (CN)

(21) Appl. No.: 18/952,913

(22) Filed: Nov. 19, 2024

Related U.S. Application Data
(63) Continuation of application No. PCT/CN2023/093983, filed on May 12, 2023.

(30) Foreign Application Priority Data
May 20, 2022 (CN) 202210552589.0

(51) Int. Cl. B60L 15/20

(52) U.S. Cl. CPC B60L 15/2036; B60L 2240/423; B60L 2240/461

(57) ABSTRACT

A vehicle torque control method includes: a wheel speed of a wheel corresponding to a vehicle drive shaft is acquired by a vehicle controller, and an equivalent rotating speed of a motor is calculated based on the wheel speed of the wheel. An actual rotating speed of the motor corresponding to the drive shaft is acquired by the vehicle controller, and based on the equivalent rotating speed of the motor and the actual rotating speed of the motor corresponding to the drive shaft, an equivalent rotating speed difference of the motor corresponding to the drive shaft is calculated. A correcting torque value is acquired by the vehicle controller, based on the equivalent rotating speed difference of the motor corresponding to the drive shaft. An output torque of the motor corresponding to the drive shaft is adjusted by the vehicle controller, based on the correcting torque value.

### CROSS-REFERENCE TO RELATED APPLICATIONS

This application is a continuation application of International Patent Application No. PCT/CN2023/093983, filed on May 12, 2023, which is based on and claims priority to and benefits of Chinese Patent Application No. 202210552589.0 filed on May 20, 2022. The entire content of all of the above-referenced applications is incorporated herein by reference.

### FIELD

The present disclosure relates to the technical field of vehicles, and particularly, to a vehicle torque control method and apparatus, an electronic device, and a storage medium.

### BACKGROUND

With the development of new energy vehicle technologies, requirements for safety and comfort of new energy vehicles are increasingly high. At present, most new energy vehicles are four-wheel drive vehicles, and each wheel can obtain a power. Therefore, a response speed of a single wheel is relatively fast, and the wheel is susceptible to slip. In the related art, to solve this problem, whether the vehicle slips is generally determined by a slip ratio, so as to control the vehicle slipping. However, a vehicle speed needs to be estimated when the slip ratio is calculated, which increases the difficulty of an algorithm.

### SUMMARY

In view of the above problems, embodiments of the present disclosure provide a vehicle torque control method and apparatus for controlling a vehicle torque, an electronic device, and a storage medium to overcome or at least partially solve the above problems.

To solve the above problems, an embodiment of the present disclosure discloses a vehicle torque control method. The method includes:

A wheel speed of a wheel corresponding to a vehicle drive shaft is acquired by a vehicle controller, and an equivalent rotating speed of a motor is calculated based on the wheel speed of the wheel.

An actual rotating speed of the motor corresponding to the drive shaft is acquired by the vehicle controller, and based on the equivalent rotating speed of the motor and the actual rotating speed of the motor corresponding to the drive shaft, an equivalent rotating speed difference of the motor corresponding to the drive shaft is calculated.

A correction torque value is acquired by the vehicle controller, based on the equivalent rotating speed difference of the motor corresponding to the drive shaft.

An output torque of the motor corresponding to the drive shaft is adjusted by the vehicle controller, based on the correction torque value.

In an embodiment, that based on the equivalent rotating speed of the motor and the actual rotating speed of the motor corresponding to the drive shaft, an equivalent rotating speed difference of the motor corresponding to the drive shaft is calculated includes:

A difference between the equivalent rotating speed of the motor and the actual rotating speed of the motor corresponding to the drive shaft is calculated to obtain the equivalent rotating speed difference of the motor corresponding to the drive shaft.

In an embodiment, that a correction torque value is acquired based on the equivalent rotating speed difference of the motor corresponding to the drive shaft includes:

In response to that the equivalent rotating speed difference of the motor corresponding to the drive shaft is greater than a first threshold, acquiring the correction torque value.

In an embodiment, that a correction torque value is acquired based on the equivalent rotating speed difference of the motor corresponding to the drive shaft includes:

A wheel acceleration change rate of the wheel is acquired.

In response to that the equivalent rotating speed difference of the motor corresponding to the drive shaft is greater than the first threshold and the wheel acceleration change rate is greater than a second threshold, acquiring the correction torque value.

In an embodiment, that an output torque of the motor corresponding to the drive shaft is adjusted based on the correction torque value includes:

The motor corresponding to the drive shaft is controlled to reduce the output torque based on the correction torque value.

In an embodiment, the drive shaft includes a front axle and a rear axle. That the motor corresponding to the drive shaft is controlled to reduce the torque based on the correction torque value includes:
in response to that an equivalent rotating speed difference of a motor corresponding to the front axle is greater than a first threshold, controlling the motor corresponding to the front axle to reduce a torque based on the correction torque value, or
in response to that an equivalent rotating speed difference of a motor corresponding to the rear axle is greater than the first threshold, controlling the motor corresponding to the rear axle to reduce a torque based on the correction torque value, or
in response to that an equivalent rotating speed differences of motors corresponding to the front axle and the rear axle are greater than the first threshold, controlling the motors corresponding to the front axle and the rear axle to reduce torques based on the correction torque value.

In an embodiment, in response to that the equivalent rotating speed difference of the motor corresponding to the front axle is greater than the first threshold, the controlling the motor corresponding to the front axle to reduce the torque based on the correction torque value, includes:
controlling the motor corresponding to the front axle to reduce the torque by the correction torque value, and determining a rear axle torque incremental value for the motor corresponding to the rear axle; and in response to that the rear axle torque incremental value is great than or equal to the correction torque value, controlling the motor corresponding to the rear axle to increase the torque by the correction torque value, or in response to that the rear axle torque incremental value is less than the correction torque value, controlling the motor corresponding to the rear axle to increase the torque based on the rear axle torque incremental value.

In an embodiment, in response to that the equivalent rotating speed difference of the motor corresponding to the rear axle is greater than the first threshold, the controlling the motor corresponding to the rear axle to reduce the torque based on the correction torque value includes: controlling the motor corresponding to the rear axle to reduce the torque by the correction torque value, and determining a front axle torque incremental value for the motor corresponding to the front axle; and in response to that the front axle torque incremental value is great than or equal to the correction torque value, controlling the motor corresponding to the front axle to increase the torque by the correction torque value, or in response to that the front axle torque incremental value is less than the correction torque value, controlling the motor corresponding to the front axle to increase the torque based on the front axle torque incremental value.

In an embodiment, that an equivalent rotating speed of a motor is calculated based on the wheel speed of the wheel includes:

A transmission ratio of the wheel to the motor corresponding to the drive shaft is acquired.

The equivalent rotating speed of the motor is calculated based on the wheel speed of the wheel and the corresponding transmission ratio of the wheel.

In an embodiment, that a correction torque value is acquired includes:

The corresponding correction torque value is calculated based on the following formula:

ΔT_{fl}=k₁*Δω_{fl}+k₂*(Δω_{fl}−D₁)

where k₁ and k₂ are a proportional coefficient and a differential coefficient respectively, D₁ is an equivalent rotating speed difference of the motor corresponding to the drive shaft at a previous sampling time, Δω_{fl} is an equivalent rotating speed difference of the motor corresponding to the drive shaft at a current time, and ΔT_{fl} is the correction torque value.

In an embodiment, that a correction torque value is acquired includes:

A correction left wheel torque value corresponding to a left wheel connected to the drive shaft is acquired, and a correction right wheel torque value corresponding to a right wheel connected to the drive shaft is acquired.

Magnitudes of a larger one the correction left wheel torque value and the correction right wheel torque value are determined as the correction torque value.

In an embodiment, that an output torque of the motor corresponding to the drive shaft is adjusted based on the correction torque value includes:

A torque value lower limit is determined.

After a current output torque of the motor corresponding to the drive shaft is reduced by the correction torque value, in response to that the reduced current output torque is less than or equal to the torque value lower limit, setting the output torque of the motor corresponding to the drive shaft to be the torque value lower limit.

In an embodiment, that a torque value lower limit is determined includes:

In response to that the equivalent rotating speed difference of the motor corresponding to the drive shaft is greater than a third threshold and less than a fourth threshold, determining that the torque value lower limit is 0, wherein the fourth threshold is greater than the third threshold.

In response to that the equivalent rotating speed difference of the motor corresponding to the drive shaft is greater than the fourth threshold, determining a torque limit value of motor reversal as the torque value lower limit.

In another aspect, an embodiment of the present disclosure discloses a vehicle torque control apparatus, including:
an information acquisition module, configured to acquire a wheel speed of a wheel corresponding to a vehicle drive shaft, and acquire a rotating speed of a motor corresponding to the drive shaft;
a calculation module, configured to calculate an equivalent rotating speed based on the wheel speed of the wheel, and calculate, based on the rotating speed of the wheel and the rotating speed of the motor corresponding to the drive shaft, an equivalent rotating speed difference of the motor of the drive shaft at which the wheel is located;
a determining module, configured to acquire a correction torque value based on the equivalent rotating speed difference of the motor of the drive shaft at which the wheel is located; and
a control module, configured to adjust an output torque of the motor corresponding to the drive shaft based on the correction torque value.

In an embodiment, the calculation module includes:
an equivalent rotating speed difference calculation submodule, configured to calculate a difference between the equivalent rotating speed of the motor and the actual rotating speed of the motor corresponding to the drive shaft to obtain the equivalent rotating speed difference of the motor of the drive shaft at which the wheel is located.

In an embodiment, the determining module includes:
a first determining submodule, configured to acquire the correction torque value if the equivalent rotating speed difference of the motor of the drive shaft at which the wheel is located is greater than a rotating speed difference threshold.

In an embodiment, the determining module includes:
a second determining submodule, configured to acquire a wheel acceleration change rate of the wheel; and
a third determining submodule, configured to acquire the correction torque value if the equivalent rotating speed difference of the motor of the drive shaft at which the wheel is located is greater than the rotating speed difference threshold and the wheel acceleration change rate is greater than a wheel acceleration change rate threshold.

In an embodiment, the control module includes:
a first adjustment submodule, configured to control the motor corresponding to the drive shaft to reduce the torque based on the correction torque value.

In an embodiment, the drive shaft includes a front axle and a rear axle; and the first adjustment submodule includes:
a first adjustment unit, configured to control, when an equivalent rotating speed difference of a motor corresponding to the front axle is greater than the rotating speed difference threshold, the motor of the front axle to reduce a torque based on the correction torque value, or
control, when an equivalent rotating speed difference of a motor corresponding to the rear axle is greater than the rotating speed difference threshold, the motor of the rear axle to reduce a torque based on the correction torque value, or
control, when equivalent rotating speed differences of motors corresponding to the front axle and the rear axle are both greater than the rotating speed difference threshold, the motors of the front axle and the rear axle to reduce torques based on the correction torque value.

In an embodiment, the first adjustment unit includes:
a first adjustment subunit, configured to control, when the equivalent rotating speed difference of the motor corresponding to the front axle is greater than the rotating speed difference threshold, the motor corresponding to the front axle to reduce the correction torque value, and determine a rear axle torque incremental value increasable by the motor corresponding to the rear axle; and control, if the rear axle torque incremental value is great than or equal to the correction torque value, the motor corresponding to the rear axle to increase the torque by the correction torque value, or control, if the rear axle torque incremental value is less than the correction torque value, the motor corresponding to the rear axle to increase the torque based on the rear axle torque incremental value; and
a second adjustment subunit, configured to control, when the equivalent rotating speed difference of the motor corresponding to the rear axle is greater than the rotating speed difference threshold, the motor corresponding to the rear axle to reduce the correction torque value, and determine a front axle torque incremental value increasable by the motor corresponding to the front axle; and control, if the front axle torque incremental value is great than or equal to the correction torque value, the motor corresponding to the front axle to increase the torque by the correction torque value, or control, if the front axle torque incremental value is less than the correction torque value, the motor corresponding to the front axle to increase the torque based on the front axle torque incremental value.

In an embodiment, the calculation module includes:
a transmission ratio acquisition submodule, configured to acquire a transmission ratio of the wheel to the motor corresponding to the drive shaft; and
an equivalent rotating speed calculation submodule, configured to calculate the equivalent rotating speed of the motor based on the wheel speed of the wheel and the corresponding transmission ratio.

In an embodiment, the determining module includes:
a fourth determining submodule, configured to calculate the corresponding correction torque value based on the following formula:

ΔT_{fl}=k₁*Δω_{fl}+k₂*(Δω_{fl}−D₁),

where k₁ and k₂ are a proportional coefficient and a differential coefficient, D₁ is an equivalent rotating speed difference of the motor corresponding to the drive shaft at a previous sampling time, Δω_{fl} is an equivalent rotating speed difference of the motor corresponding to the drive shaft at a current time, and ΔT_{fl} is the correction torque value.

In an embodiment, the determining module includes:
a submodule for acquiring a corrected wheel torque value, configured to acquire a correction left wheel torque value corresponding to a left wheel connected to the drive shaft, and acquire a correction right wheel torque value corresponding to a right wheel connected to the drive shaft; and
a fifth determining submodule, configured to determine magnitudes of the correction left wheel torque value and the correction right wheel torque value, and take the larger value as the correction torque value.

In an embodiment, the control module includes:
a torque value lower limit determining submodule, configured to determine a torque value lower limit; and
a second adjustment submodule, configured to control, if a current output torque of the motor corresponding to the drive shaft is less than or equal to the torque value lower limit after the correction torque value is reduced by, the output torque of the motor corresponding to the drive shaft to be the torque value lower limit.

In an embodiment, the torque value lower limit determining submodule includes:
a first torque value lower limit determining unit, configured to determine that the torque value lower limit is 0 when the equivalent rotating speed difference of the motor corresponding to the drive shaft is greater than a first rotating speed difference threshold and less than a second rotating speed difference threshold; the second rotating speed difference threshold being greater than the first rotating speed difference threshold; and
a second torque value lower limit determining unit, configured to determine the torque value lower limit as a torque limit value of motor reversal when the equivalent rotating speed difference of the motor corresponding to the drive shaft is greater than the second rotating speed difference threshold.

In another aspect, an embodiment of the present disclosure discloses an electronic device, including a processor, a memory and a computer program stored in the memory and executable on the processor. The steps of the vehicle torque control method described above are implemented when the computer program is executed by the processor.

In another aspect, an embodiment of the present disclosure discloses a non-transitory computer-readable storage medium. The non-transitory computer-readable storage medium stores a computer program. The steps of the vehicle torque control method described above are implemented when the computer program is executed by a processor.

In another aspect, an embodiment of the present disclosure discloses a vehicle. The vehicle includes a front motor, a rear motor and a controller. The controller is configured to implement the steps of the vehicle torque control method described above.

The embodiments of the present disclosure have the following advantages.

According to the present disclosure, an equivalent rotating speed difference of a drive shaft at which a wheel is located can be calculated by a wheel speed of the wheel and a rotating speed of the drive shaft, and whether the shaft at which the wheel is located needs torque reduction can be determined based on the equivalent rotating speed difference, so that the difficulty of calculating a slip ratio is reduced. According to the present disclosure, a torque of a motor of a drive shaft corresponding to a slipping wheel can be adjusted based on a state of the single wheel and a state of the single shaft, so that a traction utilization rate of a whole vehicle is improved, thereby improving power performance of the whole vehicle, and avoiding power loss caused by control of torque reduction through the slip ratio.

### BRIEF DESCRIPTION OF THE DRAWINGS

FIG. 1 is a flowchart of a vehicle torque control method according to an embodiment of the present disclosure;

FIG. 2 is a flowchart of a vehicle torque control method according to another embodiment of the present disclosure;

FIG. 3 is a flowchart showing steps of determining slip of a front axle of a vehicle according to an embodiment of the present disclosure;

FIG. 4 is a flowchart showing steps of determining slip of a rear axle of a vehicle according to an embodiment of the present disclosure;

FIG. 5 is a flowchart showing a front axle and rear axle torque control policy according to an embodiment of the present disclosure; and

FIG. 6 is a structural block diagram of a vehicle torque control apparatus according to an embodiment of the present disclosure.

### DETAILED DESCRIPTION

To make the above objective, features and advantages of the present disclosure clearer and more comprehensible, the present disclosure is further described in detail below with reference to the accompanying drawings and implementations.

In the related art, a wheel slip ratio is acquired by a front wheel rotating speed/rear wheel rotating speed/vehicle speed. When the slip ratio is greater than a threshold, a torque of a motor is reduced, to control slip of a vehicle. However, a slip state of a single shaft and a single wheel and requirements for adjusting torques of a front axle motor and a rear axle motor are not considered, which reduces power performance of the whole vehicle. Moreover, the vehicle speed needs to be estimated when the slip ratio is calculated, which increases the difficulty of an algorithm.

One of the core ideas of embodiments of the present disclosure is to calculate, based on an equivalent rotating speed of a wheel speed of a wheel and a rotating speed of a motor of a drive shaft at which the wheel is located, an equivalent rotating speed difference of the motor of the drive shaft at which the wheel is located, calculate a corresponding corrected torque based on the equivalent rotating speed difference, and adjust a torque of the motor of the drive shaft at which a slipping wheel is located based on the corrected torque.

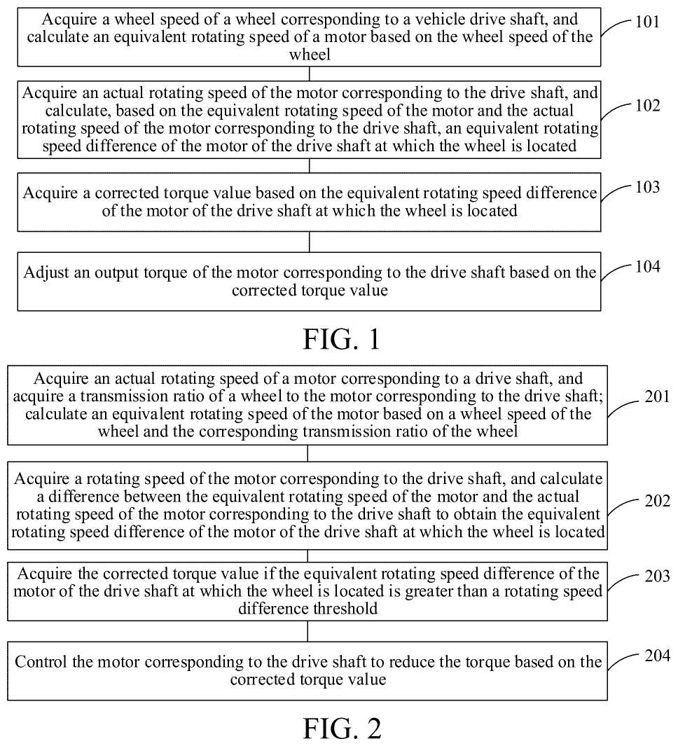

FIG. 1 is a step flowchart of a vehicle torque control method according to an embodiment of the present disclosure, which may include the following steps.

Step 101: A wheel speed of a wheel corresponding to a vehicle drive shaft is acquired, and an equivalent rotating speed of a motor is calculated based on the wheel speed of the wheel.

In the embodiment of the present disclosure, the vehicle may be a four-wheel drive vehicle or a two-wheel drive vehicle. The two front-wheel drive vehicle means that two front wheels or two rear wheels are driven by one motor. Four-wheel drive vehicles may fall into dual-motor drive, three-motor drive and four-motor drive. A dual-motor four-wheel drive vehicle means that one motor drives two front wheels and the other motor drives two rear wheels. A three-motor four-wheel drive vehicle means one motor drives two wheels at a shaft, and two wheels on the other side are driven by two motors. The four-motor four-wheel drive vehicle means two motors drive two front wheels and two motors drive two rear wheels. It should be noted that the examples in the embodiment of the present disclosure are all explained with a dual-motor four-wheel drive vehicle (that is, a front axle drives two wheels by one motor, and a rear axle drives two wheels by the other motor) as an example.

In sensors of the vehicle, a wheel speed sensor has a small number of (usually 8 or 16) teeth of a tooth ring and low resolution (usually 45° or 22.5°), and therefore cannot accurately and effectively identify a rapid and small rotating speed fluctuation, but a motor rotating speed sensor features high resolution (usually about 360°/4096≈0.088°), and therefore can accurately and effectively identify a small fluctuation. Therefore, the measurement of the motor rotating speed is faster and more accurate than that of the wheel speed. In addition, a torque at the motor end is first transmitted to a speed reducer first and then to left and right wheels through mechanical transmission, there is a certain delay in this process. A changing trend of the wheel speed of the wheel can be predicted in advance by the motor rotating speed, which is more conducive to vehicle control.

Therefore, the wheel speed of each wheel of the vehicle can be collected by the wheel speed sensor, and a transmission ratio between the wheel and the motor can be inquired. Based on the wheel speed of the wheel and the transmission ratio, the equivalent rotating speed of the motor is calculated when the wheel speed of the wheel is equivalent to the rotating speed at the motor end corresponding to the drive shaft.

Step 102: An actual rotating speed of the motor corresponding to the drive shaft is acquired, and an equivalent rotating speed difference of the motor of the drive shaft at which the wheel is located is calculated based on the equivalent rotating speed of the motor and the actual rotating speed of the motor corresponding to the drive shaft.

In the embodiment of the present disclosure, the rotating speed of the motor corresponding to the vehicle drive shaft can be collected by a motor resolver sensor, and a difference between the equivalent rotating speed of the wheel and the rotating speed of the motor corresponding to the drive shaft can be calculated, so that the equivalent rotating speed difference of the motor of the drive shaft at which the wheel is located can be obtained.

Step 103: A correction torque value is acquired based on the equivalent rotating speed difference of the motor of the drive shaft at which the wheel is located.

In an embodiment, whether the wheel slips can be determined based on an equivalent shaft speed difference, and then the correction torque value corresponding to eliminating the equivalent rotating speed difference can be calculated based on the equivalent rotating speed difference and an equivalent rotating speed difference at a previous time.

Step 104: An output torque of the motor corresponding to the drive shaft is adjusted based on the correction torque value.

In the embodiment of the present disclosure, a torque of a motor of a drive shaft at which a slipping wheel is located can be reduced based on the correction torque value. In addition, a torque of a motor of a drive shaft at which a non-slipping wheel is located can be increased, thereby avoiding the slip of the wheel.

According to the present disclosure, the equivalent rotating speed difference of the motor of the drive shaft at which a wheel is located can be calculated by a wheel speed of the wheel and a rotating speed of the drive shaft, and whether the shaft at which the wheel is located slips can be determined based on the equivalent rotating speed difference, so as to determine whether the torque needs to be reduced, so that the difficulty of calculating a slip ratio is reduced. According to the present disclosure, a torque of a motor of a drive shaft where a slipping wheel is located can be adjusted based on a state of the single wheel and a state of the single shaft, so that traction utilization rate of a whole vehicle is improved, thereby improving power performance of the whole vehicle, and avoiding power loss caused by torque reduction through the slip ratio.

It can be understood that the wheel speed of the wheel corresponding to the drive shaft mentioned above means the wheel speed of the wheel connected to the drive shaft. The wheel speed of one of wheels connected to the drive shaft may be acquired, or wheel speeds of both wheels may be acquired, and an equivalent rotating speed of the motor corresponding to the wheels is calculated by the wheel speed and is compared with an actual rotating speed of the motor, so that which wheel on the drive shaft slips can be determined.

FIG. 2 is a step flowchart of a vehicle torque control method according to another embodiment of the present disclosure, which may include the following steps.

Step 201: An actual rotating speed of a motor corresponding to a drive shaft is acquired, and a transmission ratio of a wheel to the motor corresponding to the drive shaft is acquired; and an equivalent rotating speed of the motor is calculated based on a wheel speed of the wheel and the corresponding transmission ratio of the wheel.

In an example, wheel speeds of wheels, ω_{fl}, ω_{fr}, ωᵣₗ, and ωᵣᵣ, can be collected by an in-vehicle wheel speed sensor, and the collected wheel speed of each wheel is filtered. A filtering method is not limited to first-order low-pass filtering, mean filtering and Kalman filtering.

A transmission ratio between each wheel and the motor can be inquired, and the equivalent rotating speed of each wheel is calculated by the following formulas (1) and (2):

$${ω}_{fleq} = {ω}_{fl} * {i}_{{fl}^{}} , {ω}_{freq} = {ω}_{fr} * {i}_{fr} ; and \qquad formula ( 1 )$$

$${ω}_{rleq} = {ω}_{rl} * {i}_{rl} , {ω}_{rreq} = {ω}_{rr} * {i}_{rr} , \qquad formula ( 2 )$$

where ω_{fl}, ω_{fr}, ωᵣₗ, and ωᵣᵣ denote a left front wheel speed, a right front wheel speed, a left rear wheel speed and a right rear wheel speed respectively, and i_{fl}, i_{fr}, iᵣₗ, and iᵣᵣ denote transmission ratios of a left front wheel, a right front wheel, a left rear wheel and a right rear wheel to a motor respectively. The transmission ratios are greater than 1. ω_{fleq}, ω_{freq}, ω_{rleq}, and ω_{rreq} denote equivalent rotating speeds of the left front wheel, the right front wheel, the left rear wheel and the right rear wheel respectively.

Step 202: A rotating speed of the motor corresponding to the drive shaft is acquired, and a difference between the equivalent rotating speed of the motor and the actual rotating speed of the motor corresponding to the drive shaft is calculated to obtain the equivalent rotating speed difference of the motor of the drive shaft at which the wheel is located.

In the embodiment of the present disclosure, rotating speeds of corresponding motors can be collected based on the motor resolver sensor. The collected rotating speeds of the front axle motor and the rear axle motor are set to ω_{mf} and ωₘᵣ. The rotating speeds of the motors are filtered. The filtering method is not limited to first-order low-pass filtering, mean filtering and Kalman filtering.

In a non-slip state, a motor is connected to the drive shaft by a differential. According to the principle of an open differential, a relationship between the equivalent rotating speed of the wheel speed of each front wheel and the rotating speed of the motor of the front wheel is shown in formula (3), and a relationship between the equivalent rotating speed of the wheel speed of each rear wheel and the rotating speed of the motor of the rear wheel is shown in formula (4).

$$2 {ω}_{mf} = {ω}_{fleq} + {ω}_{freq} ; and \qquad formula ( 3 )$$

$$2 {ω}_{mr} = {ω}_{rleq} + {ω}_{rreq} , \qquad formula ( 4 )$$

where ω_{mf} is the rotating speed of the front wheel motor, and ωₘᵣ is the rotating speed of the rear wheel motor.

Therefore, there is a difference between the rotating speed of a motor and the equivalent rotating speed of the motor when a wheel slips.

The difference between the equivalent rotating speed of the motor and the actual rotating speed of the motor corresponding to the drive shaft is calculated to obtain the equivalent rotating speed difference of the motor of the drive shaft at which the wheel is located, and the equivalent rotating speed differences of the motors of the drive shafts where the left front wheel, the right front wheel, the left rear wheel and the right rear wheel are respectively located are calculated by formulas (5) and (6):

$$Δ {ω}_{fl} = {ω}_{fleq} - {ω}_{mf} , Δ {ω}_{fr} = {ω}_{freq} - {ω}_{mf} ; and \qquad formula ( 5 )$$

$${Δω}_{rl} = {ω}_{rleq} - {ω}_{mr} , {Δω}_{rr} = {ω}_{rreq} - {ω}_{mr} , \qquad formula ( 6 )$$

where Δω_{fl}, Δω_{fr}, Δωᵣₗ, and Δωᵣᵣ denote the equivalent rotating speed differences of left front wheel, the right front wheel, the left rear wheel and the right rear wheel respectively.

In the present disclosure, whether a wheel slips is determined by the equivalent rotating speed difference of the motor. Compared with the wheel speed sensor, the motor rotating speed sensor can identify vehicle slipping earlier and improve real-time performance and accuracy of control.

Step 203: The correction torque value is acquired if the equivalent rotating speed difference of the motor of the drive shaft at which the wheel is located is greater than a rotating speed difference threshold (e.g., a first threshold).

In the embodiment of the present disclosure, a rotating speed difference threshold may be set based on the rotating speed of the motor of the shaft where the wheel is located. When the equivalent rotating speed difference is greater than the rotating speed difference threshold, it can be determined that the drive shaft where the wheel is located slips and needs to be corrected, and the correction torque value can be calculated based on the equivalent rotating speed difference.

In an embodiment of the present disclosure, that the correction torque value is acquired may include: The corresponding correction torque value is calculated based on the following formula (7):

$$Δ {T}_{fl} = {k}_{1} * Δ {ω}_{fl} + {k}_{2} * ( Δ {ω}_{fl} - {D}_{1} ) , \qquad formula ( 7 )$$

Where k₁ and k₂ are a proportional coefficient and a differential coefficient and can be obtained by looking up a table, D₁ is an equivalent rotating speed difference of the motor corresponding to the drive shaft at a previous sampling time, Δω_{fl} is an equivalent rotating speed difference of the motor corresponding to the drive shaft at a current time, and ΔT_{fl} is the correction torque value.

In an embodiment of the present disclosure, step 103 may include the following sub-steps S21 and S22.

Sub-step S21: A wheel acceleration change rate of the wheel is acquired.

In an embodiment, derivation can be performed based on the wheel speeds of the wheels obtained earlier to obtain accelerations α_{fl}, α_{fr}, αᵣₗ, and αᵣᵣ, of the wheels, which denote the wheel accelerations of the left front wheel, the right front wheel, the left rear wheel and the right rear wheel respectively, and then the wheel acceleration change rate can be calculated based on the wheel accelerations of the left front wheel, the right front wheel, the left rear wheel and the right rear wheel.

Sub-step S22: The correction torque value is acquired if the equivalent rotating speed difference of the motor of the drive shaft at which the wheel is located is greater than the rotating speed difference threshold and the wheel acceleration change rate is greater than a wheel acceleration change rate threshold (e.g., a second threshold).

In the embodiment of the present disclosure, whether the motor of the drive shaft where the wheel is located slips may be determined based on another method, that is, a rotating speed difference threshold can be set based on the rotating speed of the motor of the shaft where the wheel is located.

In an example, rotating speed difference thresholds S1, S2, S5 and S6 (S5>S1>0, S6>S2>0) and wheel acceleration change rate thresholds A1 and A2 (A1>0, A2>0) are preset. When S1<Δω_{fl}<S5 and α_{fl}>A1, it is determined that the left front wheel ordinarily slips, and when Δω_{fl}>S5, it is determined that the vehicle severely slips. When S2<Δω_{fr}<S6 and α_{fr}>A2, it is determined that the right front wheel ordinarily slips, and when Δω_{fr}>S6, it is determined that the vehicle severely slips. When the left front wheel or the right front wheel ordinarily or severely slips, it is determined that the front axle slips, otherwise, it is determined that no front axle slips.

In an embodiment of the present disclosure, when Δω_{fl}>S5 and α_{fl}>A1, it is determined that the vehicle severely slips, and when Δω_{fr}>S6 and α_{fr}>A2, it is determined that the vehicle severely slips.

Rotating speed difference thresholds S3, S4, S7 and S8 (S7>S3>0, S8>S4>0) and wheel acceleration change rate thresholds A3 and A4 (A3>0, A4>0) are preset. When S3<Δωᵣₗ<S7 and αᵣₗ>A3, it is determined that the left rear wheel ordinarily slips, and when Δωᵣₗ>S7, it is determined that the vehicle severely slips. When S4<Δωᵣᵣ<S8 and αᵣᵣ>A4, it is determined that the right rear wheel ordinarily slips, and when Δωᵣᵣ>S8, it is determined that the vehicle severely slips. When the left rear wheel or the right rear wheel ordinarily or severely slips, it is determined that the rear axle slips, otherwise, it is determined that no rear axle slips.

In an embodiment of the present disclosure, when <Δωᵣₗ>S7 and αᵣₗ>A3, it is determined that the vehicle severely slips, and when Δωᵣᵣ>S8 and αᵣᵣ>A4, it is determined that the vehicle severely slips.

Step 204: The motor correspond to the drive shaft is controlled to reduce the torque based on the correction torque value.

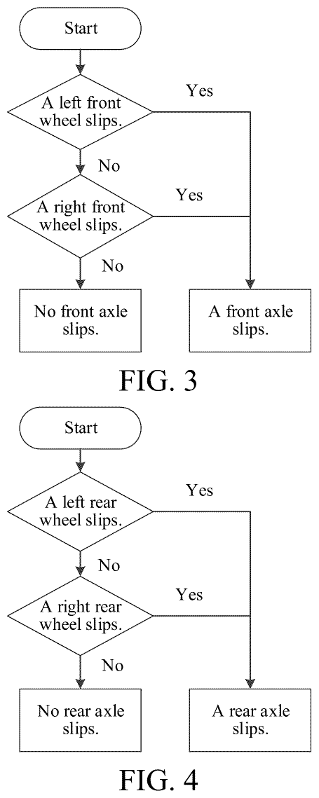

FIG. 3 is a flowchart showing determining of slip of a front axle of a vehicle according to an embodiment of the present disclosure.

In the embodiment of the present disclosure, whether wheels corresponding to a front drive shaft slip can be determined based on a comparison between the equivalent rotating speed difference of the front wheels and the rotating speed difference threshold in step 202. If any wheel at the front drive shaft slips, it is determined that the front drive shaft slips. For example, when S1<<Δω_{fl}<S5 and α_{fl}>A1, the left front wheel slips, indicating that the front axle slips. When neither of both wheels of the front drive shaft slips, it is determined that no front drive shaft slips. For example, when Δω_{fl}<S1 and α_{fl}<A1, and Δω_{fr}<S2 and α_{fr}<A2, neither of the left front wheel and the right front wheel slips, indicating that no front axle slips.

FIG. 4 is a flowchart showing determining of slip of a rear axle of a vehicle according to an embodiment of the present disclosure.

In the embodiment of the present disclosure, whether wheels corresponding to a rear drive shaft slip can be determined based on a comparison between the equivalent rotating speed difference of the rear wheels and the rotating speed difference threshold in step 202. If any wheel at the rear drive shaft slips, it is determined that the rear drive shaft slips. For example, when S3<Δωᵣₗ<S7 and αᵣₗ>A3, it is determined that the left rear wheel ordinarily slips, and the rear axle slips. When neither of both wheels of the rear drive shaft slips, it is determined that no front drive shaft slips. For example, when Δωᵣₗ<S3 and αᵣₗ<A3, and Δωᵣᵣ<S4 and αᵣᵣ<A4, it indicates neither of both wheels of the rear drive shaft slips, and no corresponding rear axle slips.

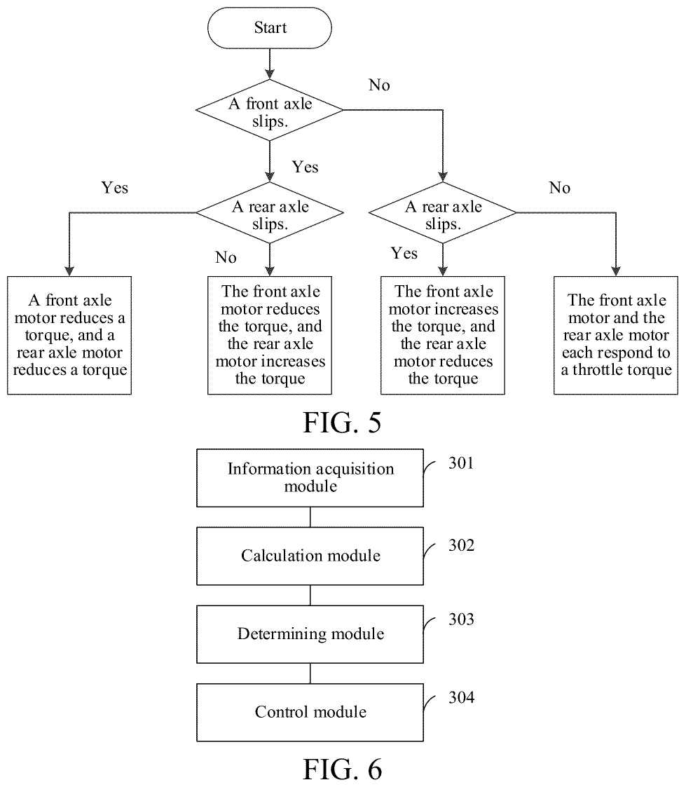

FIG. 5 is a flowchart showing a front axle and rear axle torque control policy according to an embodiment of the present disclosure.

In the embodiment of the present disclosure, when the front drive shaft or the rear drive shaft slips, the torque of the slipping drive shaft is reduced, and the torque of the non-slipping drive shaft is increased. When both the front drive shaft and the rear drive shaft slip, the torques of the front drive shaft and the rear drive shaft are reduced at the same time. When neither of the front drive shaft and the rear drive shaft slips, neither of the torques of the front drive shaft and the rear drive shaft is reduced, and the front drive shaft and the rear drive shaft each respond to a throttle torque.

When it is determined that the motor of the drive shaft where the wheel is located needs to adjust the torque, the motor corresponding to the drive shaft is controlled to reduce the torque. For example, when it is determined that the left front wheel or the right front wheel slips while no wheel at the rear axle slips, the front axle motor reduces the torque by a value that is the corrected torque calculated for the slipping wheel, and the rear axle motor increases the torque by the corresponding value.

When it is determined that the left rear wheel slips or the right rear wheel slips while no wheel at the front axle slips, the rear axle motor reduces the torque by a value that is the corrected torque calculated for the slipping wheel. In an embodiment of the present disclosure, the front axle motor increases the torque by the corresponding value.

In the embodiment of the present disclosure, the torque can be transferred from one end with low traction to the other end with high traction, that is, the torque of the motor of the drive shaft at which a slipping wheel is located is reduced, and the torque of the motor of the drive shaft at which a non-slipping wheel is located is increased. This avoids a loss of power, and can ensure power of the whole vehicle while restraining the slipping, thereby ensuring power performance of the vehicle.

When it is determined that the left front wheel or the right front wheel slips at the front axle while the left rear wheel or the right rear wheel slips at the rear axle, each of the torques of the front axle motor and the rear axle motor is reduced by a value that is a corrected torque calculated for the slipping wheel. Otherwise, the front axle motor and the rear axle motor each respond to the throttle torque.

In an embodiment of the present disclosure, the drive shaft includes a front axle and a rear axle. Step 204 may include sub-step S23.

Step S23: When an equivalent rotating speed difference of a motor corresponding to the front axle is greater than the rotating speed difference threshold, the motor of the front axle is controlled to reduce a torque based on the correction torque value, or when an equivalent rotating speed difference of a motor corresponding to the rear axle is greater than the rotating speed difference threshold, the motor of the rear axle is controlled to reduce a torque based on the correction torque value, or when equivalent rotating speed differences of motors corresponding to the front axle and the rear axle are both greater than the rotating speed difference threshold, the motors of the front axle and the rear axle are controlled to reduce torques based on the correction torque value.

In an embodiment of the present disclosure, that when an equivalent rotating speed difference of a motor corresponding to the front axle is greater than the rotating speed difference threshold, the motor of the front axle is controlled to reduce a torque based on the correction torque value, or that when an equivalent rotating speed difference of a motor corresponding to the rear axle is greater than the rotating speed difference threshold, the motor of the rear axle is controlled to reduce a torque based on the correction torque value may include:

When the equivalent rotating speed difference of the motor corresponding to the front axle is greater than the rotating speed difference threshold, the motor corresponding to the front axle is controlled to reduce the correction torque value, and a rear axle torque incremental value increasable by the motor corresponding to the rear axle is determined; and if the rear axle torque incremental value is great than or equal to the correction torque value, the motor corresponding to the rear axle is controlled to increase the torque by the correction torque value, or if the rear axle torque incremental value is less than the correction torque value, the motor corresponding to the rear axle is controlled to increase the torque based on the rear axle torque incremental value; or
when the equivalent rotating speed difference of the motor corresponding to the rear axle is greater than the rotating speed difference threshold, the motor corresponding to the rear axle is controlled to reduce the correction torque value, and a front axle torque incremental value increasable by the motor corresponding to the front axle is determined; and if the front axle torque incremental value is great than or equal to the correction torque value, the motor corresponding to the front axle is controlled to increase the torque by the correction torque value, or if the front axle torque incremental value is less than the correction torque value, the motor corresponding to the front axle is controlled to increase the torque based on the front axle torque incremental value.

In the embodiment of the present disclosure, when one of the two drive shafts slips, requirements for a total torque are kept constant by increasing the torque of one of the drive shafts and reducing the torque of the other drive shaft, and the power performance of the vehicle is ensured while the slip is restrained or eliminated.

In an embodiment of the present disclosure, that the correction torque value is acquired includes:

A correction left wheel torque value corresponding to a left wheel connected to the drive shaft is acquired, and a correction right wheel torque value corresponding to a right wheel connected to the drive shaft is acquired. Magnitudes of the correction left wheel torque value and the correction right wheel torque value are determined, and the larger value is taken as the correction torque value, thereby better restraining or eliminating slipping.

In the embodiment of the present disclosure, when both wheels corresponding to the drive shaft are about to slip, corrected wheel torque values of both wheels can be obtained, and the larger one is used as the correction torque value to adjust the torque of the motor of the drive shaft corresponding to the wheel. For example, when both the left front wheel and the right front wheel slip, the correction torque value of the left front wheel is 30 N*m, and the correction torque value of the right front wheel is 40 N*m. In this case, the correction torque value of the motor on the front axle is 40 N*m.

In an embodiment of the present disclosure, that an output torque of the motor corresponding to the drive shaft is adjusted based on the correction torque value may include:

A torque value lower limit is determined.

If a current output torque of the motor corresponding to the drive shaft is less than or equal to the torque value lower limit after the current output torque is reduced by the correction torque value, the output torque of the motor corresponding to the drive shaft is controlled to be the torque value lower limit.

In an embodiment, a slip state of each wheel may fall into severe slip and ordinary slip. Under different slip states, lower limits of the output torque of the motor corresponding to the drive shaft are different. For example, in the case of ordinary slip, the lower limit is 0. In the case of severe slip, the output torque of the motor corresponding to the drive shaft may not be able to balance the equivalent rotating speed difference after being reduced to 0. In this case, the output torque needs to continue to be reduced to a physical limit value of motor reversal. According to the present disclosure, the torque value lower limit can be self-adaptive based on a slipping degree of the vehicle, thereby avoiding a case that the torque can only be adjusted to 0 during severe slip of the vehicle, but the equivalent rotating speed difference of the motor of the drive shaft corresponding to a slipping wheel has not been adjusted well. This improves efficiency of torque adjustment of the motor of the drive shaft corresponding to the slipping wheel.

In an embodiment of the present disclosure, that a torque value lower limit is determined may include:

It is determined that the torque value lower limit is 0 when the equivalent rotating speed difference of the motor corresponding to the drive shaft is greater than a first rotating speed difference threshold (e.g., a third threshold) and less than a second rotating speed difference threshold (e.g., a fourth threshold). The second rotating speed difference threshold is greater than the first rotating speed difference threshold.

The torque value lower limit is determined as a torque limit value of motor reversal when the equivalent rotating speed difference of the motor corresponding to the drive shaft is greater than the second rotating speed difference threshold.

It should be noted that for simplicity of description, the method embodiments are expressed as a series of action combinations, but a person skilled in the art should be aware that the embodiments of the present disclosure are not limited by the described action sequence, because according to embodiments of the present disclosure, certain steps may be performed in other sequences or simultaneously. A person skilled in the art should also be aware that the embodiments described in the specification are examples, and that the actions involved are not necessarily required for embodiments of the present disclosure.

FIG. 6 shows a vehicle torque control apparatus according to the present disclosure, which includes:
an information acquisition module 301, configured to acquire a wheel speed of a wheel corresponding to a vehicle drive shaft, and acquire an actual rotating speed of a motor corresponding to the drive shaft;
a calculation module 302, configured to calculate an equivalent rotating speed of the motor based on the wheel speed of the wheel, and calculate, based on the equivalent rotating speed of the motor and the actual rotating speed of the motor corresponding to the drive shaft, an equivalent rotating speed difference of the motor of the drive shaft at which the wheel is located;
a determining module 303, configured to acquire a correction torque value based on the equivalent rotating speed difference of the motor of the drive shaft at which the wheel is located; and
a control module 304, configured to adjust an output torque of the motor corresponding to the drive shaft based on the correction torque value.

In an embodiment, the calculation module 302 may include:
an equivalent rotating speed difference calculation submodule, configured to calculate a difference between the equivalent rotating speed of the motor and the actual rotating speed of the motor corresponding to the drive shaft to obtain the equivalent rotating speed difference of the motor of the drive shaft at which the wheel is located.

In an embodiment, the determining module 303 may include:
a first determining submodule, configured to acquire the correction torque value if the equivalent rotating speed difference of the motor of the drive shaft at which the wheel is located is greater than a rotating speed difference threshold.

In an embodiment, the determining module 303 may include:
a second determining submodule, configured to acquire a wheel acceleration change rate of the wheel; and
a third determining submodule, configured to acquire the correction torque value if the equivalent rotating speed difference of the motor of the drive shaft at which the wheel is located is greater than the rotating speed difference threshold and the wheel acceleration change rate is greater than a wheel acceleration change rate threshold.

In an embodiment, the control module 304 may include:
a first adjustment submodule, configured to control the motor corresponding to the drive shaft to reduce the torque based on the correction torque value.

In an embodiment, the drive shaft includes a front axle and a rear axle; and the first adjustment submodule may include:
a first adjustment unit, configured to control, when an equivalent rotating speed difference of a motor corresponding to the front axle is greater than the rotating speed difference threshold, the motor of the front axle to reduce a torque based on the correction torque value, or
control, when an equivalent rotating speed difference of a motor corresponding to the rear axle is greater than the rotating speed difference threshold, the motor of the rear axle to reduce a torque based on the correction torque value, or
control, when equivalent rotating speed differences of motors corresponding to the front axle and the rear axle are both greater than the rotating speed difference threshold, the motors of the front axle and the rear axle to reduce torques based on the correction torque value.

In an embodiment, the first adjustment unit may include:
a first adjustment subunit, configured to control, when the equivalent rotating speed difference of the motor corresponding to the front axle is greater than the rotating speed difference threshold, the motor corresponding to the front axle to reduce the correction torque value, and determine a rear axle torque incremental value increasable by the motor corresponding to the rear axle; and control, if the rear axle torque incremental value is great than or equal to the correction torque value, the motor corresponding to the rear axle to increase the torque by the correction torque value, or control, if the rear axle torque incremental value is less than the correction torque value, the motor corresponding to the rear axle to increase the torque based on the rear axle torque incremental value; and
a second adjustment subunit, configured to control, when the equivalent rotating speed difference of the motor corresponding to the rear axle is greater than the rotating speed difference threshold, the motor corresponding to the rear axle to reduce the correction torque value, and determine a front axle torque incremental value increasable by the motor corresponding to the front axle; and control, if the front axle torque incremental value is great than or equal to the correction torque value, the motor corresponding to the front axle to increase the torque by the correction torque value, or control, if the front axle torque incremental value is less than the correction torque value, the motor corresponding to the front axle to increase the torque based on the front axle torque incremental value.

In an embodiment, the calculation module 302 may include:
a transmission ratio acquisition submodule, configured to acquire a transmission ratio of the wheel to the motor corresponding to the drive shaft; and
an equivalent rotating speed calculation submodule, configured to calculate the equivalent rotating speed of the motor based on the wheel speed of the wheel and the corresponding transmission ratio.

In an embodiment, the determining module 303 may include:
a fourth determining submodule, configured to calculate the corresponding correction torque value based on the following formula:

ΔT_{fl}=k₁*Δω_{fl}+k₂*(Δω_{fl}−D₁),

where k₁ and k₂ are a proportional coefficient and a differential coefficient and can be obtained by looking up a table, D₁ is an equivalent rotating speed difference of the motor corresponding to the drive shaft at a previous sampling time, <Δω_{fl} is an equivalent rotating speed difference of the motor corresponding to the drive shaft at a current time, and ΔT_{fl} is the correction torque value.

In an embodiment, the determining module 303 may include:
a submodule for acquiring a corrected wheel torque value, configured to acquire a correction left wheel torque value corresponding to a left wheel connected to the drive shaft, and acquire a correction right wheel torque value corresponding to a right wheel connected to the drive shaft; and
a fifth determining submodule, configured to determine magnitudes of the correction left wheel torque value and the correction right wheel torque value, and take the larger value as the correction torque value.

In an embodiment, the control module 304 may include:
a torque value lower limit determining submodule, configured to determine a torque value lower limit; and
a second adjustment submodule, configured to control, if a current output torque of the motor corresponding to the drive shaft is less than or equal to the torque value lower limit after the current output torque is reduced by the correction torque value, the output torque of the motor corresponding to the drive shaft to be the torque value lower limit.

In an embodiment, the torque value lower limit determining submodule may include:
a first torque value lower limit determining unit, configured to determine that the torque value lower limit is 0 when the equivalent rotating speed difference of the motor corresponding to the drive shaft is greater than a first rotating speed difference threshold and less than a second rotating speed difference threshold; the second rotating speed difference threshold being greater than the first rotating speed difference threshold; and
a second torque value lower limit determining unit, configured to determine the torque value lower limit as a torque limit value of motor reversal when the equivalent rotating speed difference of the motor corresponding to the drive shaft is greater than the second rotating speed difference threshold.

In another aspect, an embodiment of the present disclosure discloses a computer-readable storage medium. The computer-readable storage medium stores a computer program. The steps of the vehicle torque control method described above are implemented when the computer program is executed by a processor.

In another aspect, an embodiment of the present disclosure discloses an electronic device, including a processor, a memory and a computer program stored in the memory and executable on the processor. The steps of the vehicle torque control method described above are implemented when the computer program is executed by the processor.

In another aspect, an embodiment of the present disclosure discloses a vehicle. The vehicle includes a front motor, a rear motor and a controller. The controller is configured to implement the steps of the vehicle torque control method described above.

Since the apparatus embodiment is substantially similar to the method embodiment, the description is relatively simple. For relevant parts, refer to the description of the method embodiment.

The embodiments in this specification are described in a progressive manner, and the description of each embodiment focuses on differences from other embodiments. Mutual reference may be made to the same and similar parts of the embodiments.

A person skilled in the art should understand that, the embodiments of the present disclosure may be provided as methods, apparatuses, or computer program products. Therefore, the present disclosure may use a form of hardware-only embodiments, software-only embodiments, or embodiments combining software and hardware. In addition, the embodiments of the present disclosure may use a form of a computer program product implemented on one or more computer-usable storage media (including but not limited to a disk memory, a CD-ROM and an optical memory) including computer-usable program code.

The embodiments of the present disclosure are described with reference to flowcharts and/or block diagrams of the method, terminal device (system), and computer program product in the embodiments of the present disclosure. It should be understood that computer program instructions can implement each process and/or block in the flowcharts and/or block diagrams and a combination of processes and/or blocks in the flowcharts and/or block diagrams. These computer program instructions may be provided to a processor of a general purpose computer, a special purpose computer, an embedded processor or other programmable data processing terminal devices to produce a machine, so that the instructions executed by a processor of a computer or other programmable data processing terminal devices are used to produce an apparatus configured to implement functions specified in one or more processes of the flowcharts and/or one or more blocks of the block diagrams.

These computer program instructions may be stored in a computer-readable memory that can instruct a computer or other programmable data processing terminal devices to operate in a manner, so that the instructions stored in the computer-readable memory are used to produce a product including an instruction apparatus, and the instruction apparatus implements functions specified in one or more processes of the flowcharts and/or one or more blocks of the block diagrams.

These computer program instructions may be loaded on a computer or other programmable data processing terminal devices, so that a series of operation steps are performed on the computer or other programmable terminal devices to produce computer-implemented processing, and therefore the instructions executed on the computer or other programmable terminal devices are used to provide steps for implementing functions specified in one or more processes of the flowcharts and/or one or more blocks of the block diagrams.

Although some embodiments of the present disclosure have been described, additional changes and modifications may be made to these embodiments by a person skilled in the art once basic inventive concepts are known. Therefore, the appended claims are to include the embodiments as well as all changes and modifications that fall within the scope of the embodiments of the present disclosure.

Finally, it should be noted that relational terms herein such as “first” and “second” are merely used to distinguish one entity or operation from another entity or operation without necessarily requiring or implying any actual such relationship or order between such entities or operations. Moreover, the terms “include”, “comprise” or any other variants thereof are to cover non-exclusive inclusion, so that a process, method, article or terminal device including a series of elements not only includes those elements, but also includes those elements that are not explicitly listed, or also includes elements inherent to this process, method, article or terminal device. Without further limitation, the element defined by the sentence “including a . . . ” does not exclude that other identical elements are also present in the process, method, article or terminal device including the elements.

The vehicle torque control method and apparatus, the electronic device, and the storage medium according to the present disclosure are described above in detail. Although the principles and implementations of the present disclosure are described by applying examples herein, the descriptions of the above embodiments are merely to help understand the method and the core idea of the method according to the present disclosure. In addition, for a person of ordinary skill in the art, changes may be made to the implementations and application range based on the idea of the present disclosure. To sum up, the contents of this specification should not be construed as a limitation to the present disclosure.

What is claimed is:

1. A method for controlling a vehicle torque, comprising:
acquiring, by a vehicle controller, a wheel speed of a wheel corresponding to a vehicle drive shaft, and calculating an equivalent rotating speed of a motor based on the wheel speed of the wheel;
acquiring, by the vehicle controller, an actual rotating speed of the motor corresponding to the drive shaft, and calculating, based on the equivalent rotating speed of the motor and the actual rotating speed of the motor corresponding to the drive shaft, an equivalent rotating speed difference of the motor corresponding to the drive shaft;
acquiring, by the vehicle controller, a correction torque value based on the equivalent rotating speed difference of the motor corresponding to of the drive shaft; and
adjusting, by the vehicle controller, an output torque of the motor corresponding to the drive shaft based on the correction torque value.

2. The method according to claim 1, wherein the calculating, based on the equivalent rotating speed of the motor and the actual rotating speed of the motor corresponding to the drive shaft, an equivalent rotating speed difference of the motor corresponding to the drive shaft comprises:
calculating a difference between the equivalent rotating speed of the motor and the actual rotating speed of the motor corresponding to the drive shaft to obtain the equivalent rotating speed difference of the motor corresponding to the drive shaft.

3. The method according to claim 1, wherein the acquiring a correction torque value based on the equivalent rotating speed difference of the motor corresponding to the drive shaft comprises:
in response to that the equivalent rotating speed difference of the motor corresponding to the drive shaft is greater than a first threshold, acquiring the correction torque value.

4. The method according to claim 3, wherein the acquiring a correction torque value based on the equivalent rotating speed difference of the motor corresponding to the drive shaft comprises:
acquiring a wheel acceleration change rate of the wheel; and
in response to that the equivalent rotating speed difference of the motor corresponding to the drive shaft is greater than the first threshold and the wheel acceleration change rate is greater than a second threshold, acquiring the correction torque value.

5. The method according to claim 1, wherein the adjusting an output torque of the motor corresponding to the drive shaft based on the correction torque value comprises:
controlling the motor corresponding to the drive shaft to reduce the output torque based on the correction torque value.

6. The method according to claim 5, wherein the drive shaft comprises a front axle and a rear axle; and
the controlling the motor corresponding to the drive shaft to reduce the output torque based on the correction torque value comprises:
in response to that an equivalent rotating speed difference of a motor corresponding to the front axle is greater than a first threshold, controlling the motor corresponding to the front axle to reduce a torque based on the correction torque value, or
in response to that an equivalent rotating speed difference of a motor corresponding to the rear axle is greater than the first threshold, controlling the motor corresponding to the rear axle to reduce a torque based on the correction torque value, or
in response to that an equivalent rotating speed differences of motors corresponding to the front axle and the rear axle are greater than the first threshold, controlling the motors corresponding to the front axle and the rear axle to reduce torques based on the correction torque value.

7. The method according to claim 6, wherein in response to that the equivalent rotating speed difference of the motor corresponding to the front axle is greater than the first threshold, the controlling the motor corresponding to the front axle to reduce the torque based on the correction torque value, comprises:
controlling the motor corresponding to the front axle to reduce the torque by the correction torque value, and determining a rear axle torque incremental value for the motor corresponding to the rear axle; and
in response to that the rear axle torque incremental value is great than or equal to the correction torque value, controlling the motor corresponding to the rear axle to increase the torque by the correction torque value, or in response to that the rear axle torque incremental value is less than the correction torque value, controlling the motor corresponding to the rear axle to increase the torque based on the rear axle torque incremental value.

8. The method according to claim 6, wherein in response to that the equivalent rotating speed difference of the motor corresponding to the rear axle is greater than the first threshold, the controlling the motor corresponding to the rear axle to reduce the torque based on the correction torque value comprises:
controlling the motor corresponding to the rear axle to reduce the torque by the correction torque value, and determining a front axle torque incremental value for the motor corresponding to the front axle; and
in response to that the front axle torque incremental value is great than or equal to the correction torque value, controlling the motor corresponding to the front axle to increase the torque by the correction torque value, or in response to that the front axle torque incremental value is less than the correction torque value, controlling the motor corresponding to the front axle to increase the torque based on the front axle torque incremental value.

9. The method according to claim 1, wherein the calculating an equivalent rotating speed of a motor based on the wheel speed of the wheel comprises:
acquiring a transmission ratio of the wheel to the motor corresponding to the drive shaft; and
calculating the equivalent rotating speed of the motor based on the wheel speed of the wheel and the corresponding transmission ratio of the wheel.

10. The method according to claim 1, wherein the acquiring a correction torque value comprises:
calculating the correction torque value based on a formula:
ΔT_{fl}=k₁*Δω_{fl}+k₂*(Δω_{fl}−D₁),
wherein k₁ and k₂ are a proportional coefficient and a differential coefficient respectively, D₁ is an equivalent rotating speed difference of the motor corresponding to the drive shaft at a previous sampling time, Δω_{fl} is an equivalent rotating speed difference of the motor corresponding to the drive shaft at a current time, and ΔT_{fl} is the correction torque value.

11. The method according to claim 1, wherein the acquiring a correction torque value comprises:
acquiring a correction left wheel torque value corresponding to a left wheel connected to the drive shaft, and acquiring a correction right wheel torque value corresponding to a right wheel connected to the drive shaft; and
determining a larger one of the correction left wheel torque value and the correction right wheel torque value as the correction torque value.

12. The method according to claim 1, wherein the adjusting an output torque of the motor corresponding to the drive shaft based on the correction torque value comprises:
determining a torque value lower limit; and
after a current output torque of the motor corresponding to the drive shaft is reduced by the correction torque value, in response to that the reduced current output torque is less than or equal to the torque value lower limit, setting the output torque of the motor corresponding to the drive shaft to be the torque value lower limit.

13. The method according to claim 12, wherein the determining a torque value lower limit comprises:
in response to that the equivalent rotating speed difference of the motor corresponding to the drive shaft is greater than a third threshold and less than a fourth threshold, determining that the torque value lower limit is 0, wherein the fourth threshold is greater than the third threshold; and
in response to that the equivalent rotating speed difference of the motor corresponding to the drive shaft is greater than the fourth threshold, determining a torque limit value of motor reversal as the torque value lower limit.

14. An electronic device for controlling a vehicle torque, comprising a processor, a memory and a computer program stored in the memory and executable by the processor, when the computer program is executed by the processor, the processor is configured to perform operations comprising:
acquiring a wheel speed of a wheel corresponding to a vehicle drive shaft, and calculating an equivalent rotating speed of a motor based on the wheel speed of the wheel;
acquiring an actual rotating speed of the motor corresponding to the drive shaft, and calculating, based on the equivalent rotating speed of the motor and the actual rotating speed of the motor corresponding to the drive shaft, an equivalent rotating speed difference of the motor corresponding to the drive shaft;
acquiring a correction torque value based on the equivalent rotating speed difference of the motor corresponding to of the drive shaft; and
adjusting an output torque of the motor corresponding to the drive shaft based on the correction torque value.

15. The electronic device according to claim 14, wherein the calculating, based on the equivalent rotating speed of the motor and the actual rotating speed of the motor corresponding to the drive shaft, an equivalent rotating speed difference of the motor corresponding to the drive shaft comprises:
calculating a difference between the equivalent rotating speed of the motor and the actual rotating speed of the motor corresponding to the drive shaft to obtain the equivalent rotating speed difference of the motor corresponding to the drive shaft.

16. The electronic device according to claim 14, wherein the acquiring a correction torque value based on the equivalent rotating speed difference of the motor corresponding to the drive shaft comprises:
in response to that the equivalent rotating speed difference of the motor corresponding to the drive shaft is greater than a first threshold, acquiring the correction torque value.

17. The electronic device according to claim 16, wherein the acquiring a correction torque value based on the equivalent rotating speed difference of the motor corresponding to the drive shaft comprises:
acquiring a wheel acceleration change rate of the wheel; and
in response to that the equivalent rotating speed difference of the motor corresponding to the drive shaft is greater than the first threshold and the wheel acceleration change rate is greater than a second threshold, acquiring the correction torque value.

18. The electronic device according to claim 14, wherein the adjusting an output torque of the motor corresponding to the drive shaft based on the correction torque value comprises:
controlling the motor corresponding to the drive shaft to reduce the output torque based on the correction torque value.

19. A non-transitory computer-readable storage medium storing a computer program, wherein the computer program is executed by a processor to cause the processor to perform operations comprising:
acquiring a wheel speed of a wheel corresponding to a vehicle drive shaft, and calculating an equivalent rotating speed of a motor based on the wheel speed of the wheel;
acquiring an actual rotating speed of the motor corresponding to the drive shaft, and calculating, based on the equivalent rotating speed of the motor and the actual rotating speed of the motor corresponding to the drive shaft, an equivalent rotating speed difference of the motor corresponding to the drive shaft;
acquiring a correction torque value based on the equivalent rotating speed difference of the motor corresponding to of the drive shaft; and
adjusting an output torque of the motor corresponding to the drive shaft based on the correction torque value.

20. A vehicle, comprising a front motor, a rear motor, and a controller, the controller being configured to implement the method for controlling a vehicle torque according to claim 1.
